(19) United States
(12) Patent Application Publication
(10) Pub. No.: US 2009/0261157 A1
(43) Pub. Date: Oct. 22, 2009

(54) CUSTOMER SERVICE CENTER BASED ON TAGS

(76) Inventors: Sanjeev Kumar, Sunnyvale, CA (US); Laurent Felix Philonenko, San Francisco, CA (US); Muralidhar K. Sitaram, Los Altos, CA (US)

Correspondence Address: BRINKS HOFER GILSON & LIONE, P.O. BOX 10395, CHICAGO, IL, 60610, US

(21) Appl. No.: 12/107,375

(22) Filed: Apr. 22, 2008

(51) Int. Cl. G06F 17/00

(52) U.S. Cl. 235/375

(57) ABSTRACT

In one embodiment, a processor is operable to transmit a customer request based on a content tag. The content tag is associated with content. The content tag is at least one of a character, a word, a term, a name, a symbol, or combinations thereof. The content tag and the content are stored in a memory. The processor is operable to receive agent availability information of customer agents. The agent availability information includes availability information for multiple communication channels. In one example, the agent availability information received may include availability information of qualified customer agents, where qualified customer agents are associated with an agent tag, and the content tag is mapped to the agent tag.

### BACKGROUND

The present disclosure relates generally to customer service center systems.

A customer service center may handle electronic communication between customers and customer agents. In some examples, a customer service center includes an Automatic Call Distribution (ACD) functionality integrated with a Private Branch Exchange (PBX). The ACD functionality routes incoming calls to a group of customer agents and queues calls not connected to an available customer agent. However, a small or midsized company may find an ACD too difficult and/or expensive to operate and/or configure.

Hunt group functionality is simpler than ACD functionality. A hunt group is a method of distributing phone calls from a single destination number to a group of several phone lines. However, hunt groups may not provide enough intelligence for many small and midsized companies. Hunt groups may also be difficult to configure.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 illustrates one embodiment of a customer service center system;

FIG. 2 illustrates one embodiment of a display page in the customer facing system of FIG. 1; and

FIG. 3 illustrates one embodiment of a method for using tags in the customer service center of FIG. 1.

### DESCRIPTION OF EXAMPLE EMBODIMENTS

### Overview

By way of introduction, the example embodiments described below include an apparatus, logic encoded in a tangible media, and a method for using tags in a customer service center.

According to a first embodiment, a method is provided for using tags in a customer service center. A customer request is received where the customer request includes a content tag. The content tag is associated with content. The content tag is at least one of a character, a word, a term, a name, a symbol, or combinations thereof. A requested communication channel is determined based on the customer request. Customer agents available to receive the customer request are determined based on the requested communication channel and the content tag.

In a second embodiment, an apparatus is provided. A processor is operable to transmit a customer request based on a content tag. The content tag is associated with content. The content tag and content are stored in a memory. The processor is operable to receive agent availability information of customer agents. The agent availability information includes availability information for multiple communication channels.

In a third embodiment, logic encoded in a tangible media is provided. When executed, the logic is operable to receive a customer request that includes a content tag. The logic is also operable to determine a requested communication channel based on the customer request. The logic is further operable to determine customer agents available to receive the customer request based on the requested communication channel and the content tag.

The present invention is defined by the following claims, and nothing in this section should be taken as a limitation on those claims. Further aspects and advantages of the invention are discussed below in conjunction with the example embodiments.

### Example Embodiments

A customer service center system may use pre-defined content tags to match customer agents to customer requests. Customer agents may be employees of an organization. A customer of the organization may use a customer facing system that displays content to customers. An example of the customer facing system may include a web server and a computer, where the computer includes a web browser. Examples of content may include product description pages, frequently asked questions, instructions, self-help pages, etc. The pre-defined content tags may be associated with the content or a portion of the content. For example, a content tag may be “FAQ” and be associated with frequently asked questions. The frequently asked questions may be displayed on a display page of the customer facing system. A link may be displayed on the display page with the frequently asked questions. In response to the customer selecting the link, a customer request may be transmitted to a customer service center. The customer request may include the content tag, such as “FAQ.” The customer service center may map the content tag to the customer agents available to receive the customer request based on the content tag.

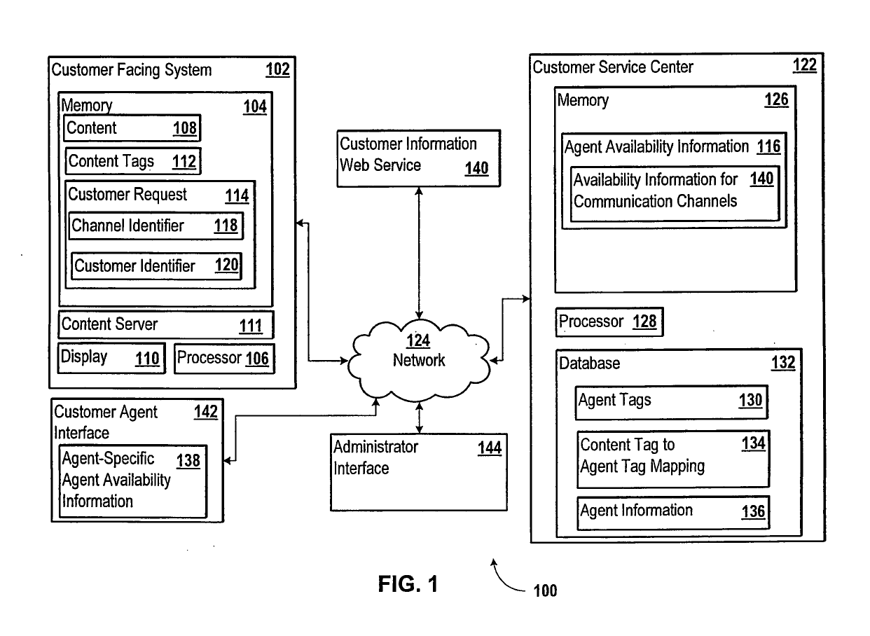

FIG. 1 illustrates one embodiment of a customer service center system 100. The system 100 may include a customer facing system 102, a customer service center 122, a customer agent interface 142, an administrator interface 144, and a customer information web service 140. The system 100 may include more, fewer, or different components.

The customer facing system 102 may be any computer, system, or device used by a customer of a company, such as a computer, a cell phone, a personal digital assistant, a web browser on a computer connected to a web server, or a telephone. The company may be any organization providing customer service and should not be limited to a legal definition of the term “company.” The company may include a third party service provider, such as a call center service provider. In other examples, the system 100 may include multiple customer facing systems 102.

The customer facing system 102 may include a memory 104 and a processor 106. The processor 106 may be in communication with the memory 104. The processor may also be in communication with additional components, such as a display 110. The processor 106 may be a general processor, central processing unit, server, application specific integrated circuit (ASIC), digital signal processor, field programmable gate array (FPGA), digital circuit, analog circuit, or combinations thereof. The processor 106 may be one or more processes or devices operable to display content 108 on the display 110.

The memory 104 may be any now known, or later discovered, storage device. The memory 104 may be a non-volatile and/or volatile memory, such as a random access memory (RAM), a read-only memory (ROM), an erasable programmable read-only memory (EPROM), or flash memory. The memory 104 may include an optical, magnetic (hard-drive) or other memory device. The display 110 may be any electro-optical device for displaying data, such as a liquid crystal display (LCD), a cathode ray tube (CRT), an electro-luminescent display, a plasma display panel (PDP), a vacuum fluorescent display (VFD), or other display device.

The memory 104 may include the content 108 and content tags 112. The content 108 may be any electronic collection of information, now known or later discovered, such as an image, a video stream, text, audio, a web page, a file, etc. or any combination thereof. Examples of content 108 may include product description pages, frequently asked questions, instructions, self-help pages, etc.

The term “content tag,” as used herein, is a tag associated with the content 108 or with a portion of the content 108. The term “tag,” as used herein, is at least one of a character, a word, a term, a name, a symbol, or combinations thereof, associated with a piece of information, thereby describing the piece of information or enabling identification of the piece of information, or both.

A tag may be chosen and associated with the piece of information formally or informally and by any automated or manual process including, for example a content author, a user of the system 100, a customer, an employee of the company, a member of a community, etc. The portion of the content 108 may be tagged at any level of resolution, such as by a word, sentence, paragraph, image, section, entire web page, etc. The same content 108 or portion of content 108 may be tagged with more than one content tag 112. Also, different portions of the content 108 may be tagged by the same content tag 112.

The processor 106 may be operable to receive the content 108 and/or content tags 112, in whole or in part, from a content server 111 and store in the memory 104. The customer facing system 102 or some other component in the system 100 may include the content server 111. The content server 111 may be any device or software component operable to retrieve content, such as a web server, web application server, file server, file system, media server, database, or any combination thereof. The content server 111 may store and retrieve associations between content 108 and content tags 112. For example, one of the content tags 112 may be stored within a web page. In another example, one of the content tags 112 may be stored along with a reference to the content 108 in a database.

The processor 106 may be operable to display a content tag 112 on the display 110 as a link. The link may be any user input control operable to receive a selection signal by the user, such as a hyperlink, an <HREF> element in a hypertext mark-up language (HTML), a button, a tab, a menu item, etc.

The processor 106 may be operable to transmit a customer request 114 based on the content tag 112 in response to selection of the link. In some examples, the customer request 114 may include the content tag 112. The customer request 114 may be transmitted by any protocol now known or later discovered, such as hypertext transfer protocol (HTTP), Hypertext Transfer Protocol over Secure Socket Layer (HTTPS), Wireless Application Protocol (WAP), Simple Object Access Protocol (SOAP), a proprietary protocol, etc. The customer request 114 may represent a request by the user to communicate with a customer agent about the content 108 associated with the content tag 112. Alternatively or additionally, the customer request 114 may represent a request by the user to obtain agent availability information 116 for customer agents that may be available to communicate with the customer about the content 108 tagged by the content tag 112.

In some examples, the customer request 114 may include a channel identifier 118. The channel identifier 118 may identify a communication channel via which the user would like to communicate with the customer agent. The communication channel may be any communication channel now known or later discovered for communicating between two individuals or between an individual and a system, such as, e-mail, phone, instant message, short message service (SMS), etc. The customer request 114 may also include a customer identifier 120. The customer identifier 120 may identify the customer initiating the customer request 114.

In one example, the customer request 114 may be transmitted as an HTTP request based on a URL included in the link, such as when the link is a hyperlink. In other examples, the processor 106 may be operable to construct the customer request 114 in response to the user's selection of the link. Thus, the processor 106 may be operable to construct the customer request 114 in response to the user's selection of the link displayed in an operating system or in an application other than a browser, such as a word processing program, a dialog box displaying information about a program crash, an e-mail program, etc.

The processor 106 may be operable to display the agent availability information 116 received in response to transmission of the customer request 114. The processor 106 may display the agent availability information 116 in a widget in response to selection of the link. The widget is a user input area and/or area of the display page to display the agent availability information 116. The widget may be displayed in proximity to the content 108 using technology such as a browser plug-in, a Java applet, an Active X Control, etc. In other examples, the widget may be a new display page, such as a new web page.

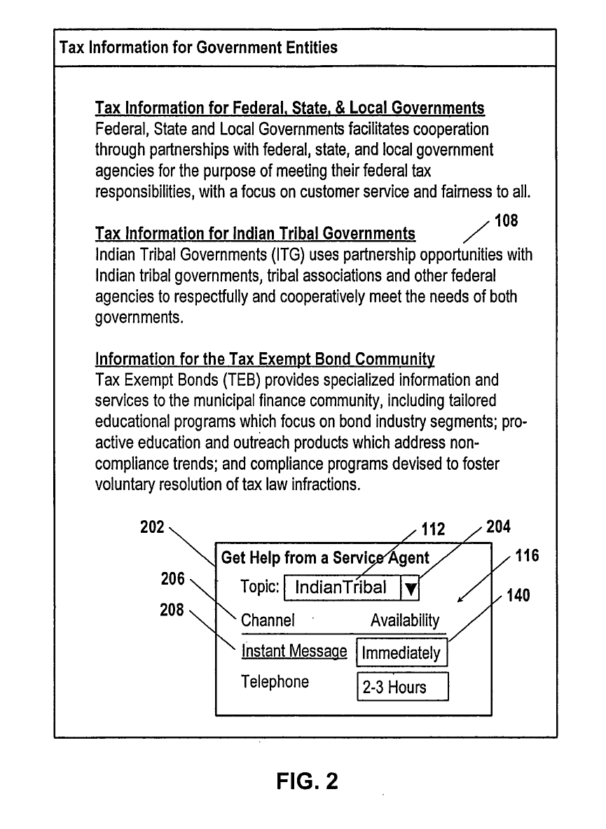

In the above examples, the customer request 114 to obtain the agent availability information 116 is transmitted in response to selection of the link. However, in other examples, the processor 106 may be operable to transmit the customer request 114 without a selection of the link. The processor 106 may then be operable to display the agent availability information 116 in the widget in proximity to the content 108 instead of the link, as illustrated in FIG. 2.

FIG. 2 illustrates one embodiment of a display page in the customer facing system 102 of FIG. 1. A portion of the content 108 may be displayed on the display page. The portion of the content 108 may be associated with the content tag 112. For example, a paragraph relating to Indian Tribal Governments is associated with the content tag 112 “IndianTribal” and is displayed along with other portions of the content 108. Other content tags 112 may be associated with other portions, such as other paragraphs, of the content 108. The widget 202 may be displayed on the display page in proximity to the content 108.

In examples where multiple portions of the content 108 are tagged with corresponding content tags 112 and the multiple portions of the content 108 are displayed on the display page, the corresponding content tags 112 may be represented as one link or one widget 202, as is illustrated in FIG. 2. In some examples, the user may be able to select one of multiple content tags 112 using a user input control 204 displayed on the one widget 202, where the selected content tag 112 is included in the customer request 114. In other examples, text corresponding to each of the content tags 112 may be displayed instead of the content tags 112. In still other examples, the multiple content tags 112 that are represented by one link or one widget 202 may be included in the customer request 114 and not be displayed. Alternatively, the processor 106 may be operable to display a separate link or widget 202 for each of the corresponding content tags 112. Where one portion of the content 108 is associated with multiple content tags 112, each of the multiple content tags 112 may be displayed instead of a single content tag 112.

In the examples where the widget is a new display page, the new display page may be generated by the customer facing system 102. Alternatively, the new display page may be generated by a customer service center 122 included in the customer service center system 100 of FIG. 1.

The customer service center 122 may be connected via a network 124 to the customer facing system 102. In other examples, the customer service center 122 and the customer facing system 102 are on the same device in order to centralize administration. The customer service center 122 may be any device or combination of devices operable to receive the customer request 114. For example, the customer service center 122 may be a computer, a cluster of computers, a device, a cluster of devices, an application specific integrated circuit (ASIC), a server, etc. The customer service center 122 may be operable to receive the customer request 114 using any protocol now known or later discovered, such as, HTTP, HTTPS, WAP, SOAP, a proprietary protocol, etc.

The customer service center 122 may include a memory 126. The memory 126 may be any now known, or later discovered, storage device. The memory 126 may be a non-volatile and/or volatile memory, such as a random access memory (RAM), a read-only memory (ROM), an erasable programmable read-only memory (EPROM), or flash memory. The memory 104 may include an optical, magnetic (hard-drive) or other memory device.

The customer service center 122 may also include a processor 128 that may be operable to receive the customer request 114. The processor 106 may be in communication with the memory 104. The processor may also be in communication with additional components. The processor 128 may be a general processor, central processing unit, server, application specific integrated circuit (ASIC), digital signal processor, field programmable gate array (FPGA), digital circuit, analog circuit, or combinations thereof.

The processor 128 may also be operable to map the content tag 112 to an agent tag 130. The term “agent tag,” as used herein, is defined as a tag associated with a customer agent. The tag may represent anything at all, such as an interest, an area of expertise, a product, a concept, etc., that is associated with one or more customer agents. As with any tag, an agent tag may be created formally or informally, and by any automated or manual process. The agent tags 130 may be stored in a database 132 as database entries. The database 132 may be included in the customer service center 122 or the database 132 may be accessed by the customer service center 122 over the network 124.

The database 132 may be any electronic collection of information that is organized so that it can be accessed, managed and updated, such as a relational database management system (RDBMS), an optic oriented database, an extensible mark-up language (XML) database, a file system, etc. The database 132 may include database entries, such as the agent tags 130. A database entry is information that may be retrieved from the database 132 using a unique key, such as a primary key value, etc. The database entry may be stored in multiple locations in the database 132, such as in multiple tables in RDBMS.

One or more database entries may be associated in the database 132 with one or more other database entries. Any method of associating database entries in a database now known, or later discovered, may be used. In some examples, a first database entry is associated with a second database entry by including a unique key in the second database entry to identify the first database entry. In other examples, the first database entry is associated with the second database entry by including a unique key in the first database entry to identify the second database entry. In still other examples, an association database entry includes a unique key to identify the first database entry and a unique key to identify the second database entry.

The content tags 112 may be mapped to the agent tags 130 by associating the content tags 112 with the agent tags 130 in the database 132. In one example, the database 132 may include database entries, such as a content tag to agent tag mapping 134, to store known mappings. The content tag to agent tag mapping 134 may associate agent tags 130 stored as database entries in the database 132 with content tags 112 also stored as database entries in the database 132.

Additionally, or alternatively, the processor 128 may map the content tag 112 to the agent tag 130 using a rule or a preference, such as mapping a particular content tag 112 to a default agent tag 130 if the particular content tag 112 is not stored in the database 132.

In addition to mapping the content tag 112 to the agent tag 130, the processor 128 may be operable to map agent tags 130 to customer agents. To do so, the processor 128 may be operable to associate agent tags 130 with customer agents in the database 132. For example, the database 132 may include agent information 136 stored as database entries in the database 132, where the agent information 136 may include information about each customer agent, such as a set of agent tags 130 that are associated with each of the customer agents. The agent information 136 may also include additional or different information for each of the customer agents, such as a username, a phone number, e-mail address, instant message address, etc.

By mapping the agent tags 130 to customer agents, the processor 128 may be operable to generate a list of qualified customer agents. Each of the qualified customer agents may be a registered customer agent associated with the agent tag 130 that was mapped from the content tag 112. A registered customer agent may be a customer agent that has corresponding agent information 136 stored in the database 132 and that is configured to receive customer requests 114. In other examples, the qualified customer agents may be all of the registered customer agents. In still other examples, the qualified customer agents may be a subset of their registered customer agents, where the subset is determined based on some factor other than the agent tag 130.

In some examples, the list of the qualified customer agents may be further narrowed to a list of available customer agents based on agent availability information 116. The processor 128 of the customer service center 122 may be operable to determine the agent availability information 116 from agent-specific agent availability information 138 based on the customer request 114. In one example, the processor 128 may be operable to receive the agent-specific agent availability information 138 from the agent information 136 in the database 132. In another example, the processor 128 may be operable to receive the agent-specific agent availability information 138 over the network 124.

The agent availability information 116 may include information about the availability of the customer agents. The agent availability information 116 may include aggregate availability information and/or availability information specific to one or more customer agents. For example, the agent availability information 116 may include information indicating when any customer agent is estimated to be available to communicate with the user about the content 108 associated with the content tag 112 included in the customer request 114. Additionally, or alternatively, the agent availability information 116 may include information indicating when a specific customer agent—as opposed to just any customer agent—is estimated to be available to communicate with the customer.

The agent availability information 116 may also include availability information for communication channels 140. A communication channel 206 may be any communication channel now known or later discovered for communicating between two individuals or between an individual and a system, such as, e-mail, phone, instant message, short message service (SMS), etc. For example, the availability information for communication channels 140 may include information indicating when any customer agent is estimated to be available to communicate with the customer via instant messaging and when any customer agent is estimated to be available to communicate with the customer via the telephone. The availability information for communication channels 140 may include aggregate or agent specific information about availability of one or more customer agents on a particular communication channel.

The agent availability information 116 may include an indication of whether any customer agent is immediately available to handle the customer request 114. In other examples, the agent availability information 116 may include an estimated time at which any customer agent may be available to handle the customer request 114. In still other examples, the agent availability information 116 may include an indication that no agent is available on any channel.

In contrast to the agent availability information 116, the agent-specific availability information 138 may include availability information specific to a customer agent that is not based on any particular customer request 114. Additionally, the agent-specific availability information 138 may include availability information specific to a customer agent that varies by communication channel. For example, the agent-specific agent availability information 138 may include an indication that the customer agent is estimated to be available to take a phone call in five minutes. The agent-specific agent availability information 138 may also include an indication that the customer agent is available to answer an instant message request immediately.

Any method to determine availability of customer agents now known or later discovered may be used to determine the agent availability information 116 based on the agent-specific availability information 138 and the qualified customer agents. For example, the agent-specific availability information 138 may include availability information for each of the qualified customer agents. As an example, for any given one of the qualified customer agents, the agent-specific availability information 138 may include an estimated time by which the given qualified customer agent may be available to receive a new customer request 114 on a particular communication channel. The estimated time for each of the customer agents may determine an overall estimated time of availability for the particular communication channel. In one example, a method to determine the overall estimated time of availability for that particular communication channel may be the minimum of the estimated time of availability of each of the customer agents. Thus, if only one of the qualified customer agents has an estimated time of availability equivalent to immediate availability and each of the other qualified customer agents has an estimated time of availability in the future, then the overall estimated time of availability for the communication channel 140 may be immediate availability. The agent availability information 116 may include the overall estimated time of availability for each of the communication channels. The availability information for the communication channels may include the overall estimated time of availability for each of the communication channels.

In another example, the method to determine the agent availability information 116 may be an average of estimated time of availability. If one customer agent indicates in a corresponding agent-specific agent availability information 138 that the customer agent is available on a communication channel in five minutes and a second customer agent indicates in a different agent-specific agent availability information 138 that the second customer agent is available on the communication channel in ten minutes, then the agent availability information 116 may be determined as the average of 7.5 minutes.

In addition to determining the agent availability information 116, the processor 128 of the customer service center 122 may be operable to transmit the agent availability information 116. The processor 128 may be operable to transmit the agent availability information 116 using any protocol now known or later discovered, such as, HTTP, HTTPS, WAP, SOAP, a proprietary protocol, etc. The processor 128 may be operable to transmit the agent availability information 116 to the customer facing system 102 that issued the customer request 114. In other examples, the processor 128 may be operable to transmit the agent availability information 116 to other devices or processes.

In response to receipt of the agent availability information 116, the customer facing system 102 may communicate the agent availability information 116 to the user. For example, the customer facing system 102 may display the agent availability information 116 in the display 110, as illustrated in FIG. 2.

In one example, the processor 106 of the customer facing system 102 may be operable to display the agent availability information 116 using a system of color-coded bars. A color-coded bar may be displayed for each of the communication channels. One color, such as green, may indicate that a customer agent is currently available to receive the customer request 114 on that communication channel. Another color, such as red, may indicate that no customer agent is currently available to receive the customer request 114 on that communication channel. Additionally, different colors may correspond to different ranges of estimated times of availability. For example, yellow may indicate that a customer agent may be available within the next five minutes on that communication channel.

In addition to, or instead of, displaying a system of color-coded bars, the processor 106 of the customer facing system 102 may be operable to display the estimated time of availability in units of time, such as seconds, minutes, hours, days, etc. The processor 106 may be operable to display aggregate agent availability information 116, as illustrated in FIG. 2, or the processor 106 may be operable to display availability information specific to one or more customer agents.

The processor 106 may be operable to display the agent availability information 116 on the widget 202 or may be operable to display the agent availability information 116 on any display page. In still other examples, the processor 106 of the customer facing system 102 may communicate the agent availability information 116 by converting the agent availability 116 to speech instead of or in addition to displaying the agent availability information 116. The processor 106 may be operable to periodically receive refreshed agent availability information 116 and communicate the refreshed agent availability information 116 to the user.

The user may select a communication channel 208 identified in the availability information for communication channels 140 to indicate a desire to communicate with a customer agent regarding the content 108 associated with the content tag 112. Any method of selecting an item now known or later discovered may be used, such as with a mouse, track ball, voice command, etc. For example, the communication channel 208 in the embodiment of FIG. 2 may be displayed as a hyperlink. Upon selection, the processor 106 of the customer facing system 102 may be operable to transmit the customer request 114 including the channel identifier 118. The channel identifier 118 may identify the selected communication channel. In some examples, the customer request 114 that includes the channel identifier 118 may be in a format that is the same as or substantially similar to the format of the customer request 114 transmitted to obtain the agent availability information 118. In other examples, the processor 106 may transmit a request with a different format to the customer service center 122.

As described earlier, the customer request 114 may include the content tag 112, the channel identifier 118, and/or the customer identifier 120. The processor 128 of the customer service center 122 may be operable to receive the customer request 114. The processor 128 may also be operable to determine a requested communication channel from the customer request 114. For example the requested communication channel may be determined from the channel identifier 118 included in the customer request 114. Alternatively, the requested communication channel may be determined by some other method, such as a preference of the customer identified by the customer identifier 120.

The customer agents available to receive the customer request 114 may be referred to as the available customer agents. The processor 128 may be operable to determine the available customer agents based on the requested communication channel and/or the content tag 112. For example, the processor 128 may be operable to determine the available customer agents from the agent availability information 116. As discussed above, the agent availability information 116 may be limited to registered customer agents associated with an agent tag 130 that was mapped from the content tag 112. Identifying specific customer agents that are indicated as available in the agent availability information 116 for the requested communication channel 208 may determine the available customer agents. In other examples, the processor 128 may be operable to similarly determine the available customer agents based on the agent-specific agent availability information 138.

If there are no available customer agents, the processor 128 of the customer service center 122 may be operable to perform a task, such as transmitting a message indicating that no customer agents are currently available. In such an example, the user receives the message instead of or in addition to waiting in a queue for a customer agent to become available to receive the customer request 114.

Alternatively, if there are available customer agents, the processor 128 of the customer service center 122 may be operable to transmit the customer request 114 to one of the available customer agents. The processor 128 may transmit the customer request 114 to an available agent using any number of methods.

For example, if the requested communication channel 208 is by instant messaging, the processor 128 may be operable to initiate an instant message session between the available agent and the customer associated with the customer request 114. The instant message session may be initiated using an instant messaging server or instant messaging gateway.

If the requested communication channel 208 is by telephone, then the processor 128 may be operable to initiate a phone call between the available agent and the user by dialing a phone number of the available agent and a phone number of the user using a voice gateway or voice bridge. To emulate a more traditional ACD, the customer agent may be a fictitious customer agent and the phone number of the fictitious agent may be a phone number of a call center or hunt group.

If the requested communication channel 208 is by e-mail, then the processor 128 may be operable to e-mail the available agent where the message content is included in the customer request 114. In other examples, the message content may be determined from the content tag 112 included in the customer request 114.

Before transmitting the customer request 114 to the available agent, the processor 128 of the customer service center 122 may select the available agent from the available customer agents using any method now known or later developed for making such a selection. One example may be a “round-robin” method (i.e., each of the available customer agents takes a turn at receiving a customer request 114 before an available agent receives another such request). The number of agent tags 130 associated with a customer agent that were mapped from the content tags 112 included in the customer request 114 may be used. Yet another example incorporates a preference of the available customer agents. Still another example method may be a method of fixed assignments as configured by an administrator.

The processor 128 may also be operable to check with the available agent to determine if the available agent agrees to receive the customer request 114 before transmitting the customer request 114 to the available agent. If the available agent does not agree to receive the customer request 114, the processor 128 may select a second available agent using the same or different selection method than was used to select the first available agent. If the second available agent also fails to agree to receive the customer request 114, the processor 128 may be operable to continue to check with the remaining available customer agents until either one of the available customer agents agrees to receive the customer request 114, or all of the available customer agents fail to agree to receive the customer request 114.

If all of the available customer agents fail to agree to receive the customer request 114, then the processor 128 may be operable to perform an additional task or tasks, such as, transmitting a message to the user indicating that no customer agents are currently available to receive such a request, sending an e-mail to a particular mailing list, recording a callback number for the user in a voicemail box, or initiating a phone call between the voicemail box and the user by dialing a phone number of the voicemail box and a phone number of the user using a voice gateway or voice bridge. In such examples, the user does not wait in a queue for a customer agent to become available to receive the customer request 114. The processor 128 may be operable to update the agent availability information 116 to indicate that none of the customer agents are available to receive the customer request 114 on the requested communication channel 208. In some examples, the processor 128 may also be operable to transmit updated agent availability information 116 to the customer facing system 102.

To determine if the available agent agrees to receive the customer request 114, the processor 128 of the customer service center 122 may be operable to transmit an agreement request to a customer agent interface 142 that is used by, or is associated with, the available agent. If the customer service center 122 receives an agreement from the customer agent interface 142 in response to the agreement request, then the processor 128 of the customer service center 122 may be operable to transmit the customer request 114 to the available agent as described above.

The customer agent interface 142 may be any device or component used to interact with a customer agent. For example, the customer agent interface 142 may be a web interface generated by the processor 128 of the customer service center 122. In another example, the customer agent interface 142 may be a web interface generated by a computer connected to the network 124. In still another example, the customer agent interface 142 may be any other application such as a Visual Basic application, Java Swing application, a command line tool, etc. In other examples, the customer agent interface 142 may be a web service operable to receive the agreement request and a processor operable to transmit the agreement in response to receipt of the agreement request. In one example, the customer agent interface 142 may also be an instant message session established between the customer agent and the customer service center 122.

In order to determine whether to transmit the agreement in response to the agreement request, the customer interface agent 142 may interact with the customer agent. For example, the customer agent interface 142 may be operable to display a message such as “Are you able to take a request via instant messaging?” In other examples, the customer agent interface 142 may be operable to communicate with another device, such as the customer agent's phone, to determine if an “available” button has been selected.

In still another example, the customer agent interface 142 may be operable to obtain a fallback communication channel. A fallback communication channel may be a communication channel on which the customer agent is immediately available if the customer agent is not available on the communication channel indicated in the customer request 114. For example, the customer agent interface 142 may be operable to display a second message asking that the customer agent select the fallback communication channel from a list of communication channels.

If more interaction with the customer agent is desired, such as after transmission of an agreement, the customer agent interface 142 may be operable to do so. For example, the customer agent interface 142 may be operable to display the customer's phone number for the customer agent to manually dial. The customer agent interface 142 may also be operable to receive preferences from the customer agent, such as the number of simultaneous instant messages that the customer agent is willing to accept.

The processor 128 of the customer service center 122 may also be operable to transmit other requests to the customer agent interface 142. For example, the processor 128 may be operable to periodically transmit a request for agent-specific agent availability information 138 to the customer agent interface 142. Alternatively or in addition, the customer agent interface 142 may periodically transmit agent-specific agent availability information 138. In some examples, the customer agent interface 142 may transmit agent-specific agent availability information 138 whenever the availability of the customer agent changes. The availability of the customer agent may change through a manual selection by the customer agent through the customer agent interface 142. In other examples, the customer agent interface 142 may be able to determine the availability of the customer agent. In one such example, if the customer agent is currently answering a call, he may be determined to be busy on that channel. In another such example, if the customer agent has indicated a willingness to accept two simultaneous instant messaging sessions and is currently handling only one instant messaging session, then the customer agent may be determined to be available on that channel.

The customer agent interface 142 may permit the customer agent to set global preferences that specify availability information applicable to each of the communication channels. The customer agent interface 142 may permit the agent to select from a list of time ranges to indicate an estimated time that the customer agent will be available to receive customer requests 114. The time ranges may be displayed as color-coded bars. The time ranges may be predetermined or determined based on historical data stored in the database 132 and/or on configuration settings.

The processor 128 of the customer service center 122 may be further operable to log in the database 132 information regarding agreement to receive the customer request 114. Any other information regarding receipt and servicing of customer requests 114, determining of agent availability information 116, etc., may also be logged in the database 132. This information may be later received from the database 132 and used for reporting purposes, for the purpose of selecting the available agent, or for any other purpose.

During operation, the processor 128 of the customer service center 122 may receive customer information, such as a phone number, an email address, a preferred communication channel, supported communication channels, a customer number, an instant message address, contact history, etc, about the customer identified by the customer identifier 120 that is included in the customer request 114. Alternatively or in addition, the customer information may be included in the customer request 114. In other examples, the customer information may be received from the database 132. In still other examples, the customer information may be received from a customer information web service 140 connected to the network 124. In examples where the customer information is included in the customer request 114, the processor 106 of the customer facing system 102 may be operable to receive the information from the user using user input controls displayed on a display page or on the widget described earlier. The customer agent interface 142 may display the customer information to the customer agent and/or provide a link to the customer information.

Agent availability information 116 may or may not be transmitted to the customer facing system 102. For example, the processor 106 of the customer facing system 102 may be operable to receive the agent availability information 116 and to communicate the agent availability information 116 to the user upon selection of the link representing the content tag 112. In other examples, upon selection of the link representing the content tag 112, the processor 106 may be operable to transmit the customer request 114 to the customer service center 122 and thereby direct the customer service center 122 to further transmit the customer request 114 to one of the available customer agents without first receiving the agent availability information 116.

Content tags 112 may be collaboratively created in some examples. For example, either the processor 106 of the customer facing system 102 or the processor 128 of the customer service center 122 may be operable to permit users to tag the content 108 with content tags 112. The users may create their own content tags 112 and associate each of their tags with a universal resource locator (URL) that identifies a portion or all of the content 108. The users' own content tags may be stored, for example, in the database 132. The users' own content tags may, or may not, be treated differently than default content tags 112 created by, for example, an employee of the company. Alternatively, each of the users' own content tags may be treated differently than the default content tags 112, until more than a determined number of users use the same content tag (i.e., common tag) for the same portion of the content 108. At that point, the common content tag may be treated the same as the default content tags 112 in that the customer service center 122 may receive a customer request 114 that includes the common content tag and appropriately transmit the customer request 114 to the customer agent.

The customer service center 122 may be administered using an administrator interface 144. The administrator interface 144 may be any device or component used to interact with a user. For example, the administrator interface 144 may be a web interface generated by the processor 128 of the customer service center 122. In another example, the administrator interface 144 may be a web interface generated by a computer connected to the network 124. In still another example, administrator interface 144 may be any other application, such as a Visual Basic application, a Java Swing application, a command line tool, etc.

The administrator interface 144 may permit, for example, administration of tags. The administrator interface 144 may permit entering or uploading of agent tags 130. The administrator interface 144 may permit entering or uploading of content tags 112. The administrator interface 144 may permit mapping content tags 112 to agent tags 130. Each of the agent tags 130 may be mapped to one or more content tags 112. Because, in some examples, content tags 112 may be assigned to the content 108 by users of the customer facing system 102, the processor 128 of the customer service center 122 may be operable to store the content tag 112 included in the customer request 114 in the database 132 upon receipt of the customer request 114.

The administrator interface 144 may permit registering customer agents. The administrator interface 144 may permit mapping agent tags 130 to customer agents. The administrator interface 144 may permit managing security, such as granting a particular user security privileges to authorize the particular user to register as a customer agent. The administrator interface 144 may permit configuration of the communication channels, such as adding a new communication channel and, configuring the manner in which the customer request 114 is transmitted to the customer agent.

The processor 128 of the customer service center 122 may be operable to receive registration information from an external customer agent interface. The processor 128 may be operable to configure a user as a registered customer agent from the registration information. The external customer agent interface may be used by a user that is external to the company. Thus, in some examples, the registered customer agents may be either internal or external to the company. A user that is external to the company may be a member of a user community, an employee of a service provider, an unrelated individual, etc. In some examples, the external customer agent interface may be the customer agent interface 142. In other examples, the external customer agent interface may be a different component than the customer agent interface 142. The agent availability information 116 may include information specific to customer agents external to the company and information specific to customer agents internal to the company, such as employees of the company. Thus, a user of the customer facing system 102 may decide which type of customer agent with which to communicate.

The customer service center system 100 may include multiple customer facing systems 102 belonging to multiple companies. In such a configuration, the customer service center 122 may be provided as a hosted solution configurable to add support for a new company without another installation of the customer service center 122. In such an example, the customer request 114 may include a company identifier that identifies the company that owns or controls the customer facing system 102 from which the customer request 114 was transmitted.

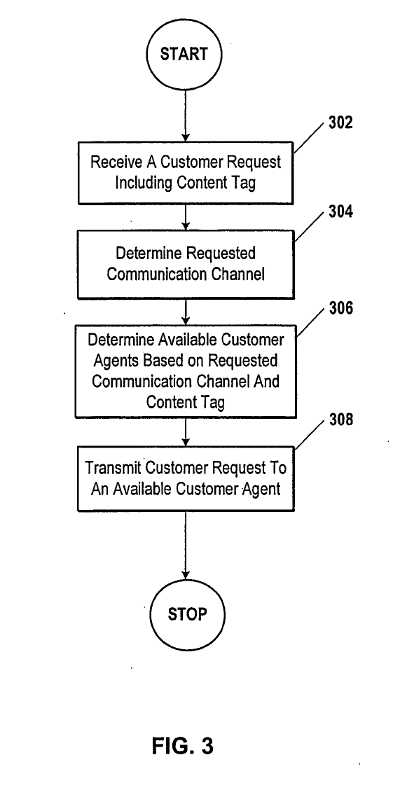

FIG. 3 illustrates one embodiment of a method for using tags in the customer service center 122 of FIG. 1 or a different customer service center. Additional, different, or fewer acts may be performed. For example, act 304 is not performed in some cases. The acts are performed in the order shown or a different order.

In act 302 of the embodiment illustrated in FIG. 3, the operation begins by receiving a customer request 114. The customer request may include the content tag 112.

In optional act 304, determining a requested communication channel. For example, the requested communication channel may be indicated by a channel identifier 118 included in the customer request 114.

In act 306, customer agents available to receive the customer request 114 are determined based on the requested communication channel and the content tag 112. For example, each of the customer agents available to receive the customer request may be qualified customer agents for the content tag 112. Qualified customer agents may be associated with an agent tag 130 that was mapped from the content tag 112. Furthermore, the customer agents available to receive the customer request 114 may be those qualified customer agents that are currently available on the requested communication channel according to the agent-specific availability information 138.

The example embodiment in block 308 includes transmitting the customer request to an available customer agent included in the customer agents available to receive the customer request 114. For example, if a user initiated the customer request and the requested communication channel is instant messaging, then transmitting the customer request includes initiating an instant message session between the available customer agent and the user.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

Different components provide different functions for implementing the customer service center system 100. The respective logic, software or instructions for implementing the processes, methods and/or techniques discussed above are provided on computer-readable storage media or memories or other tangible media, such as a cache, buffer, RAM, removable media, hard drive, other computer readable storage media, or any other tangible media. The tangible media include various types of volatile and nonvolatile storage media. The functions, acts or tasks illustrated in the figures or described herein are executed in response to one or more sets of logic or instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”), or system. Any of the devices, features, methods, and/or techniques described may be mixed and matched to create different systems and methodologies.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (We) claim:

1. An apparatus comprising:
a memory wherein content and a content tag are stored in the memory, the content tag is associated with the content, and the content tag is at least one of a character, a word, a term, a name, a symbol, or combinations thereof; and
a processor in connection with the memory operable to:
transmit a customer request based on the content tag; and
receive agent availability information of a plurality of customer agents, wherein the customer agents are able to receive customer requests based the content tag and the agent availability information includes availability information for a plurality of communication channels.

2. The apparatus of claim 1 wherein the processor is further operable to display the content tag as a link and to transmit the customer request in response to selection of the link.

3. The apparatus of claim 1 wherein the processor is further operable to display the availability information for the communication channels and to transmit a communication channel identifier in the customer request in response to a selection of one of the communication channels.

4. The apparatus of claim 1 wherein the processor is further operable to display a color indicative of an estimated time of availability on each of the communication channels, and the estimated time of availability on each of the communications channels is included in the agent availability information.

5. The apparatus of claim 1 wherein a portion of the content is an element of a web page, and the content tag is associated with the element of the web page.

6. The apparatus of claim 1 wherein the processor is further operable to associate other content tags with different portions of the content at the direction of a user, the other content tags stored in the memory.

7. The apparatus of claim 1 wherein the agent availability information includes aggregate availability information and agent-specific availability information.

8. The apparatus of claim 2 wherein the link is displayed in an application other than a web browser.

9. Logic encoded in one or more tangible media for execution and when executed operable to:
receive a customer request from a customer system, the customer request including a content tag associated with content, the content tag is at least one of a character a word, a term, a name, a symbol, or combinations thereof;
determine a requested communication channel based on the customer request; and
determine a plurality of customer agents available to receive the customer request based on the requested communication channel and the content tag.

10. A method comprising:
receiving a customer request, the customer request including a content tag, wherein the content tag is associated with content and the content tag is at least one of a character, a word, a term, a name, a symbol, or combinations thereof;
determining a requested communication channel based on the customer request; and
determining at least one customer agent available to receive the customer request based on the requested communication channel and the content tag.

11. The method of claim 10 wherein determining the at least one customer agent is based on agent availability information, the agent availability information includes availability information for each of a plurality of communication channels, and the requested communication channel is included in the communication channels.

12. The method of claim 10 further comprising:
receiving a plurality of agent-specific availability information indicative of when each of a plurality of customer agents will be available to receive customer requests on the requested communication channel; and
determining the at least one customer agent availability based on the plurality of agent-specific availability information, the requested communication channel, and the content tag.

13. The method of claim 10 further comprising:
transmitting the customer request to an available customer agent included in the at least one customer agent.

14. The method of claim 13 wherein a user initiates the customer request, the requested communication channel is instant message, and transmitting the customer request includes initiating an instant message session between the available customer agent and the user.

15. The method of claim 13 wherein a user initiated the customer request, the requested communication channel is telephone, and transmitting the customer request includes using a voice gateway to dial a first phone number of the available customer agent and a second phone number of the user.

16. The method of claim 10 further comprising:
transmitting an agreement request to a customer agent interface identified with one of the at least one customer agent;
receiving an agreement from the customer agent interface in response to the agreement request; and
transmitting the customer request to the one of the at least one customer agent in response to receipt of the agreement.

17. The method of claim 10 further comprising:
receiving a first agent information of one of the at least one customer agent, wherein the one of the at least one customer agent is external to a company and the customer request is from a customer of the company; and
receiving a second agent information of another one of the at least one customer agent, wherein the another one of the at least one customer agent is internal to the company.

18. The method of claim 10 wherein determining the requested communication channel is based on a channel identifier included in the customer request.

19. The method of claim 10 wherein determining the at least one customer agent includes mapping the content tag to an agent tag and limiting the at least one customer agent to registered customer agents associated with the agent tag.

20. The method of claim 19 further comprising:
receiving a content tag to agent tag mapping from an administrator interface, wherein mapping the content tag to the agent tag includes using the content tag to agent tag mapping.
